(19) United States
(12) Patent Application Publication
(10) Pub. No.: US 2003/0039597 A1
(43) Pub. Date: Feb. 27, 2003

(54) Close coupled catalyst with a SOx trap and methods of making and using the same

(75) Inventors: Michel Deeba, East Brunswick, NJ (US); John K. Hochmuth, Bridgewater, NJ (US); Uwe Dahle, Garbsen (DE); Stefan Brandt, Braunschweig (DE)

Correspondence Address: Engelhard Corporation, 101 Wood Avenue, P.O. Box 770, Iselin, NJ, 08830, US

(73) Assignee: ENGELHARD CORPORATION

(21) Appl. No.: 09/938,448

(22) Filed: Aug. 24, 2001

(51) Int. Cl. B01D 53/50; B01D 53/56; B01D 53/94

(52) U.S. Cl. 422/177; 422/171; 422/180

(57) ABSTRACT

The present invention relates to an article comprising a catalyst composition and a method useful for the removal of NOₓ and SOₓ contaminants from a gaseous stream, especially gaseous streams containing sulfur oxide contaminants. More specifically, the present invention is concerned with catalysts of the type generally referred to as “close coupled catalysts” which are designed to reduce pollutants in engine exhaust emissions during engine cold start conditions. The article comprises a lean burn gasoline engine having an exhaust outlet, an upstream section having a close coupled catalyst composite in communication with the exhaust outlet, and a downstream section. The upstream close coupled catalyst composite comprises a first support; a first platinum group component; and a SOₓ sorbent component selected from the group consisting of oxides and mixed oxides of barium, lanthanum, magnesium, manganese, neodymium, praseodymium, and strontium. The downstream section comprises a second support; a second platinum group component; and a NOₓ sorbent component. The upstream section has substantially no components adversely affecting three-way conversion under operating conditions.

### BACKGROUND OF THE INVENTION

1. Field of the Invention

The present invention relates to an article comprising a catalyst composition and a method useful for the removal of NOₓ and SOₓ contaminants from a gaseous stream, especially gaseous streams containing sulfur oxide contaminants. More specifically, the present invention is concerned with catalysts of the type generally referred to as “close coupled catalysts” which are designed to reduce pollutants in engine exhaust emissions during engine cold start conditions. The article comprises a lean burn gasoline engine having an exhaust outlet, an upstream section having a close coupled catalyst composite in communication with the exhaust outlet, and a downstream section. The upstream close coupled catalyst composite comprises a first support; a first platinum group component; and a SOₓ sorbent component selected from the group consisting of oxides and mixed oxides of barium, lanthanum, magnesium, manganese, neodymium, praseodymium, and strontium. The downstream section comprises a second support; a second platinum group component; and a NOₓ sorbent component. The upstream section has substantially no components adversely affecting three-way conversion under operating conditions.

2. Description of the Related Art

Emission of nitrogen oxides (“NOx”) from lean-burn engines must be reduced in order to meet emission regulation standards. Conventional three-way conversion (“TWC”) automotive catalysts are suitable for abating NOx, carbon monoxide (“CO”) and hydrocarbon (“HC”) pollutants in the exhaust of engines operated at or near stoichiometric air/fuel conditions. An air-to-fuel weight ratio of 14.65:1 is the stoichiometric ratio for a hydrocarbon fuel, such as gasoline, having an average formula CH_{1.88}. However, engines, especially gasoline-fueled engines to be used for passenger automobiles and the like, are being designed to operate under lean conditions as a fuel economy measure. Such future engines are referred to as “lean-burn engines”. That is, the ratio of air to fuel in the combustion mixtures supplied to such engines is maintained considerably above the stoichiometric ratio, e.g., at an air-to-fuel weight ratio of 18:1, so that the resulting exhaust gases are “lean”, i.e., the exhaust gases are relatively high in oxygen content.

Although lean-burn engines provide enhanced fuel economy, they have the disadvantage that conventional TWC catalysts are not effective for reducing NOx emissions from such engines because of excessive oxygen in the exhaust. The prior art discloses attempts to overcome this problem by operating lean-burn engines with brief periods of fuel-rich operation. (Engines which operate in this fashion are sometimes referred to as “partial lean-burn engines”.) It is known to treat the exhaust of such engines with a catalyst/NOx sorbent which stores NOx during periods of lean (oxygen-rich) operation, and releases the stored NOx during the rich (relatively fuel-rich) periods of operation. During periods of rich operation, the catalyst component of the catalyst/NOx sorbent promotes the reduction of NOx to nitrogen by reaction of NOx (including NOx released from the NOx sorbent) with HC, CO and/or hydrogen present in the exhaust.

The use of NOx storage (sorbent) components including alkaline earth metal oxides, such as oxides of Ca, Sr and Ba, alkali metal oxides such as oxides of K, Na, Li and Cs, and rare earth metal oxides such as oxides of Ce, La, Pr and Nd in combination with precious metal catalysts such as platinum dispersed on an alumina support, is known, as shown for example, at column 4, lines 19-25, of U.S. Pat. No. 5,473,887 (S. Takeshima et al.) At column 4, lines 53-57, an exemplary composition is described as containing barium (an alkaline earth metal) and a platinum catalyst.

The publication Environmental Catalysts For A Better World And Life, Proceedings of the 1st World Congress at Pisa, Italy, May 1-5, 1995, published by the Societa Chimica Italiana of Rome, Italy has, at pages 45-48 of the publication, an article entitled “The New Concept 3-Way Catalyst For Automotive Lean-Burn Engine Storage and Reduction Catalyst”, by Takahashi et al. (“the Takahashi et al. paper”). This article discloses the preparation of catalysts of the type described in the above-mentioned Takeshima et al. by impregnating precious metals, mainly platinum, and various alkaline and alkaline earth metal oxides, mainly barium oxide, and rare earth oxides on refractory metal oxide supports, mainly alumina, and using these catalysts for NOx purification of actual and simulated exhaust gases alternately under oxidizing (lean) and reducing (rich or stoichiometric) conditions. The conclusion is drawn in the last sentence on page 46, that NOx was stored in the catalyst under oxidizing conditions and that the stored NOx was then reduced to nitrogen under stoichiometric and reducing conditions.

SAE Paper 950809 published by the Society of Automotive Engineers, Inc., Warrendale, Pa., and entitled Development of New Concept Three-Way Catalyst for Automotive Lean-Burn Engines, by Naoto Miyoshi et al, was delivered at the International Congress and Exposition, Detroit, Mich., Feb. 27-Mar. 2, 1995. This paper, which has authors in common with the above-mentioned Takahashi et al. paper, contains a disclosure which is substantially the same as, but is more detailed than, that of the Takahashi et al. paper.

U.S. Pat. No. 5,451,558 (L. Campbell et al.) discloses a catalytic material for the reduction of NOx in combustion exhaust, e.g., from a gas turbine in a power generating stack. The material comprises an oxidation species and an adsorbent species. The oxidation species may comprise various metals including platinum group metals such as platinum, palladium or rhodium (see column 3, line 67, through column 4, line 3). The adsorbent species may comprise an alkali or alkaline earth metal carbonate, bicarbonate or hydroxide, and carbonates, especially sodium carbonate, potassium carbonate or calcium carbonate, are preferred. (See column 4, lines 24-31.) The catalytic material is applied by coating the carrier with, e.g., platinum-coated alumina and then wetting the alumina with an alkali or alkaline earth metal carbonate solution, and then drying the wetted alumina (see column 5, line 9, through column 6, line 12). The use of a metal monolith support for the material is suggested at column 5, lines 48-58.

U.S. Pat. No. 5,202,300 (M. Funabiki et al.) discloses a catalyst composition comprising a refractory support having deposited thereon an active layer containing a palladium and rhodium catalytic metal component dispersed on alumina, a cerium compound, a strontium compound, and a zirconium compound. (See the Abstract.)

U.S. Pat. No. 5,874,057 (M. Deeba et al.) and discloses a method of NOx abatement utilizing a composition comprising a NOx abatement catalyst comprising platinum and, optionally, at least one other platinum group metal catalyst which is kept segregated from a NOx sorbent material. The NOx sorbent material may be one or more of oxides, carbonates, hydroxides and mixed oxides of one or more of various alkali metals including lithium, sodium and potassium, and alkaline earth metals including magnesium, calcium, strontium and barium. As set forth at column 6, line 18 et seq of the '057 Patent, a platinum catalytic component is deemed to be essential and the utilization of the NOx sorbent material in bulk form is taught as being advantageous. The '057 Patent also teaches the optional use of ceria, for example, bulk ceria (ceria in fine particulate form) , as a component of the composition. See column 3, lines 43-44.

U.S. Pat. No. 5,376,610 (T. Takahata et al.) discloses a catalyst comprising a three-way conversion catalyst followed by a hydrocarbon oxidation catalyst and designed to provide a means for hydrocarbon conversion at cold start and stable three-way conversion (of hydrocarbons, carbon monoxide and nitrogen oxides) at operating conditions. The total amount of noble metal(s) used is 20 to 80 g/ft³ in the first (three-way conversion) layer (column 5, lines 12-14) and comprises rhodium (column 4, lines 28-35), but may also include platinum and palladium, as well as base metal catalysts. The second, hydrocarbon catalyst layer, contains either platinum or palladium or both in the amount of 5 to 50 g/ft³. Palladium is stated to be preferred, but a content of more than 50 g/ft³ is stated to be inimical to the reduction of NO to N₂ (see column 5, lines 21-39). Second and third catalysts are described in column 7, lines 17-65, and at lines 60-62, the use of a total amount of palladium of 5 to 60 g/ft³ is noted. The palladium is said to be particularly effective for hydrocarbon conversion at low temperatures (column 7, lines 26-32) and is preferably disposed in the outer layer. U.S. Pat. No. 5,376,610 does not suggest the use of a NOx sorbent and discloses a catalyst for three-way conversion suitable for stoichiometric operation. The introduction of secondary air is used to provide a lean exhaust only during cold start-up.

One known method for the reduction of NOx from lean emissions is to flow the exhaust gas containing the NOx in contact with a zeolite catalytic material comprising, for example, ZSM-5, which has been ion-exchanged with copper. Such catalyst was found to reduce NOx under lean conditions using unburned hydrocarbons in the exhaust gas as reductants, and was found to be effective at temperatures from about 350° C. to 550° C. However, such catalysts are often lacking in durability, in that catalytic performance usually decreases significantly after exposure of the catalyst to high temperature steam and/or SO₂.

Catalysts based on platinum-containing materials have also been found to abate NOx in lean environments, but such catalysts tend to produce excessive quantities of N₂O, and also to oxidize SO₂, which is present in the exhaust as a result of the oxidation of the sulfur component of fuels, to SO₃. Both products are undesirable; N₂O fosters an environmental greenhouse effect while SO₃ contributes to the formation of particulate matter in exhaust emissions by reacting to form sulfates which add to the particulate mass. Accordingly, there is a need for a catalyst that reduces NOx to N₂ while producing only limited quantities of N₂O and SO₃.

Japanese Patent H1-135541 (1989) of Toyota Jidosha K. K. et al discloses a catalyst for reducing NOx in lean car exhaust comprising zeolites that contain one or more platinum group metals, including ruthenium, by ion-exchange into the zeolite. In the exemplified embodiments, 100 grams of a washcoat comprising 150 parts zeolite and 40 parts of a mixture of alumina sol and silica sol having a 50:50 Al:Si ratio is coated onto a carrier. The following amounts of platinum group metals are then incorporated into the zeolites: in Examples 1 and 2, 1.0 gram platinum (1.27% by weight of zeolite plus platinum) and 0.2 grams rhodium (0.25% by weight zeolite plus rhodium); Example 3, 1.0 gram palladium; Example 4, 1.2 grams ruthenium (1.5% by weight zeolite plus ruthenium); Example 5, 1.2 grams iridium. Comparative examples were prepared without zeolite.

U.S. Pat. No. 5,330,732 (Ishibashi et al.) teaches that one or more of platinum, palladium and rhodium can be loaded onto zeolites “by an ion exchange and by an immersion” (column 3, lines 11-17 and 22-30) to produce NOx-reducing catalysts. Durability is improved by using at least 1.3 parts platinum. The platinum group metals are used separately in the following amounts per 100 parts by weight (“parts”) of zeolite; platinum, 1.3 parts or more; palladium, 0.8 parts or more; or rhodium, 0.7 parts or more. In terms of the weight of the metals as a percent of the combined weight of the metal plus zeolite, these quantities correspond to 1.28% platinum, 0.79% palladium, and 0.7% rhodium. The graphs of FIGS. 1-6 of Ishibashi et al. plot NOx conversion against platinum group metal loadings and show data points which appear to start at about 0.2 parts of platinum group metal, about 0.2%. However, the data show that the claimed amount of at least about 1.28% of platinum must be used to attain satisfactory NOx conversion. Preferred zeolites have a pore size of 5 to 10 Angstroms.

U.S. Pat. No. 4,206,087 (Keith et al.) teaches that a NOx-reducing catalyst may comprise 0.01 to 4 weight percent, preferably 0.03 to 1 weight percent platinum group metals dispersed on an inorganic support material that may comprise an alumino-silicate.

U.S. Pat. No. 5,041,272 (Tamura et al.) teaches that hydrogen-form zeolites are catalytically effective NOx -reducing catalyst materials at 400° C. (see Example 1, column 3).

U.S. Pat. No. 6,145,303 (Strehlau et al.) teaches a process for operating an exhaust gas treatment unit for an internal combustion engine which is operated with lean normalized air/fuel ratios over most of the operating period. The exhaust gas treatment unit contains a nitrogen oxide storage catalyst with an activity window for the storage of nitrogen oxides at normalized air/fuel ratios of greater than 1 and release of the nitrogen oxides at normalized air/fuel ratios of less than or equal to 1. The exhaust gas treatment unit also contains a sulfur trap, located upstream of the nitrogen oxides storage catalyst, with a sulfur desorption temperature above which the sulfates stored on the sulfur trap are decomposed at normalized air/fuel ratios of less than or equal to 1. The nitrogen oxides contained in the exhaust gas are stored on the nitrogen oxide storage catalyst and the sulfur oxides are stored on the sulfur trap at normalized air/fuel ratios greater than 1 and exhaust gas temperatures within the activity window. At the same time, the exhaust gas temperature just upstream of the sulfur trap is lower than its sulfur desorption temperature. By cyclic lowering of the normalized air/fuel ratio in the exhaust gas to less than 1, the stored nitrogen oxides are released again from the storage catalyst. After each predetermined number of nitrogen oxides storage cycles, sulfur is removed from the sulfur trap. This removal takes place by raising the exhaust gas temperature just upstream of the sulfur trap to above its sulfur desorption temperature and also lowering the normalized air/fuel ratio in the exhaust gas to less than 1.

U.S. Pat. No. 6,145,303 (Strehlau et al.) discloses a process for operating an exhaust gas treatment unit for an internal combustion engine which is operated during most of the operating period with lean air/fuel ratios. The exhaust gas treatment unit contains a nitrogen oxides storage catalyst and a sulfur trap which is upstream of the nitrogen oxides storage catalyst. The nitrogen oxides storage catalyst has an activity window delta-T_{NOx} between the temperatures T_{K,1} and T_{K,2} for the storage of nitrogen oxides at normalized air/fuel ratios greater than 1 and release of the nitrogen oxides at normalized air/fuel ratios less than or equal to 1 and a sulfur desorption temperature T_{K,DeSOx}, above which the sulfates stored on the catalyst are decomposed at normalized air/fuel ratios less than or equal to 1. The sulfur trap which is upstream of the nitrogen oxides storage catalyst is located at a distance from this, with a sulfur desorption temperature T_{S,DeSOx} above which sulfates stored on the sulfur trap are decomposed at normalized air/fuel ratios less than or equal to 1. There is a temperature difference delta-T_{S,K} between the sulfur trap and the storage catalyst, between the exhaust gas temperature T_{S} just upstream of the sulfur trap and the exhaust gas temperature T_{K} just upstream of the storage catalyst. The process comprises storing of the nitrogen oxides contained in the exhaust gas on the nitrogen oxides storage catalyst and storing the sulfur oxides on the sulfur trap at normalized air/fuel ratios greater than 1 and with exhaust gas temperatures T_{K} within the activity window delta-T_{NOx}. At the same time, the exhaust gas temperature T_{S} is less than the sulfur desorption temperature T_{S,DeSOx}, and cyclically lowering the normalized air/fuel ratio in the exhaust gas to less than 1 to release the, stored nitrogen oxides. Sulfur is removed from the sulfur trap after each predetermined number N₁ of nitrogen oxides storage cycles by raising the exhaust gas temperature T_{S} above the sulfur desorption temperature T_{S,DeSOx} of the sulfur trap and lowering the normalized air/fuel ratio in the exhaust gas to below 1.

Prior art catalysts as described above have a problem in practical application, particularly when the catalysts are aged by exposure to high temperatures and lean operating conditions, because after such exposure, such catalysts show a marked decrease in catalytic activity for NOx reduction, particularly at low temperature (250 to 350° C.) and high temperature (450 to 600° C.) operating conditions. It is a continuing goal to develop a SOx trap associated with an existing close coupled catalyst system that can trap SOx and minimize SOx adsorption in the NOx trap. The system should have the ability to oxidize hydrocarbons at low temperatures and to reversibly trap sulfur oxide contaminants.

### SUMMARY OF THE INVENTION

The present invention relates to an article comprising:

(A) a lean burn gasoline engine having an exhaust outlet;

(B) an upstream section having a close coupled catalyst composite in communication with the exhaust outlet, the upstream close coupled catalyst composite comprising:

(i) a first support;

(ii) first platinum group component; and

(iii) a SOₓ sorbent component selected from the group consisting of oxides and mixed oxides of barium, lanthanum, magnesium, manganese, neodymium, praseodymium, and strontium; and

(C) a downstream section comprising:

(i) a second support;

(ii) a second platinum group component; and

(iii) a NOₓ sorbent component;

wherein the upstream section has substantially no components adversely affecting three-way conversion under operating conditions.

The present invention also relates to a method for removing NOₓ and SOₓ contaminants from a gaseous stream comprising the steps of:

(A) operating a lean burn gasoline engine having an exhaust outlet;

(B) providing an upstream section comprising a close coupled catalyst composite in communication with the exhaust outlet and a downstream section:

(1) the upstream section having a close coupled catalyst composite comprising:

(i) a first support;

(ii) a first platinum group component; and

(iii) a SOₓ sorbent component selected from the group consisting of oxides and mixed oxides of barium, lanthanum, magnesium, manganese, neodymium, praseodymium, and strontium; and

(2) the downstream section comprising:

(i) a second support;

(ii) a second platinum group component; and

(iii) a NOₓ sorbent component;

wherein the upstream section has substantially no components adversely affecting three-way conversion under operating conditions;

(C) in a sorbing period, passing a lean gaseous stream comprising NOₓ and SOₓ within a sorbing temperature range through the upstream section to sorb at least some of the SOₓ contaminants and thereby provide a SOₓ depleted gaseous stream exiting the upstream section and entering the downstream section to sorb and abate at least some of the NOₓ contaminants in the gaseous stream and thereby provide a NOₓ depleted gaseous stream exiting the downstream section;

(D) in a SOₓ desorbing period, converting the lean gaseous stream to a rich gaseous stream and raising the temperature of the gaseous stream to within a desorbing temperature range to thereby reduce and desorb at least some of the SOₓ contaminants from the upstream section and thereby provide a SOₓ enriched gaseous stream exiting the upstream section; and

(E) in a NOₓ desorbing period, converting the lean gaseous stream to a rich gaseous stream to thereby desorb and reduce at least some of the NOₓ contaminants from the downstream section and thereby provide a NOₓ enriched gaseous stream exiting the downstream section.

The present invention further relates to a method of forming a catalyst composite having a close coupled upstream section and a downstream section which comprises the steps of:

(A) forming a close coupled upstream section comprising:

(i) a first support;

(ii) a first platinum group component; and

(iii) a SOₓ sorbent component selected from the group consisting of oxides and mixed oxides of barium, lanthanum, magnesium, manganese, neodymium, praseodymium, and strontium; and

(B) forming a downstream section comprising:

(i) a second support;

(ii) a second platinum group component; and

(iii) a NOₓ sorbent component;

wherein the upstream section has substantially no components adversely affecting three-way conversion under operating conditions.

### BRIEF DESCRIPTION OF THE DRAWINGS

FIG. 1 is a schematic drawing of an automobile showing a preferred embodiment of the present invention.

FIG. 2 is a graph illustrating the effect on NOx trap capacity by impregnating La₂O₃ on the upstream close coupled catalyst Sox trap composite.

### DETAILED DESCRIPTION OF THE PREFERRED EMBODIMENTS

The present invention relates to a stable close-coupled catalyst, an article comprising such a close-coupled catalyst, and a related method of operation. The close-coupled catalyst of the present invention has been designed to reduce hydrocarbon emissions from gasoline engines during cold starts in the presence of sulfur oxide contaminants. More particularly, the close-coupled catalyst is designed to reduce pollutants in automotive engine exhaust gas streams at temperatures as low as 350° C., preferably as low as 300° C. and more preferably as low as 200° C. The close-coupled catalyst of the present invention comprises a close-coupled catalyst composition which catalyzes low temperature reactions. This is indicated by the light-off temperature. The light-off temperature for a specific component is the temperature at which 50% of that component reacts. The catalyst composites of the present invention have an upstream section having a SOₓ sorbing close coupled catalyst composite in communication with an exhaust outlet and a NOₓ sorbing downstream section. The upstream section has substantially no components adversely affecting three-way conversion under operating conditions. The SOₓ sorbent component in the upstream close coupled catalyst composite is selected such that release of SOₓ occurs only under rich conditions where the SOₓ cannot be retrapped in the downstream NOₓ sorbing component.

The close-coupled catalyst is placed close to an engine to enable it to reach reaction temperatures as soon as possible. However, during steady state operation of the engine, the proximity of the close-coupled catalyst to the engine, typically less than one foot, more typically less than six inches and commonly attached directly to the outlet of the exhaust manifold exposes the close-coupled catalyst composition to exhaust gases at very high temperatures of up to 1100° C. The close-coupled catalyst in the catalyst bed is heated to high temperature by heat from both the hot exhaust gas and by heat generated by the combustion of hydrocarbons and carbon monoxide present in the exhaust gas. In addition to being very reactive at low temperatures, the close-coupled catalyst composition should be stable at high temperatures during the operating life of the engine.

In accord with the present invention, a lean burn gasoline engine with an exhaust outlet is provided with an upstream section having a close coupled catalyst composite in communication with the exhaust outlet and a downstream section. The upstream close coupled catalyst composite comprises a first support; a first platinum group component; and a SOₓ sorbent component selected from the group consisting of oxides and mixed oxides of barium, lanthanum, magnesium, manganese, neodymium, praseodymium, and strontium. The downstream section comprises a second support; a second platinum group component; and a NOₓ sorbent component. The upstream section has substantially no components adversely affecting three-way conversion under operating conditions.

The close-coupled catalyst present invention accomplishes the oxidation of carbon monoxide and hydrocarbons and reduction of nitrogen oxides at “cold start” conditions. Such conditions are as low as 350° C., preferably 300° C. and more preferably as low as 200° C. At the same time, the close-coupled catalyst composition is thermally stable upon exposure to temperature up to 1100° C. and higher during the operating life of the engine. At the same time, the close-coupled catalyst compositions provides a relatively high hydrocarbon conversion. A catalyst downstream of the close-coupled catalyst can be an underfloor catalyst or a downstream catalyst.

The present invention includes an article comprising a gasoline engine having an exhaust outlet, typically connected in communication to the inlet of an exhaust manifold. The close-coupled catalyst is in communication with the exhaust outlet and is typically connected in communication with the exhaust manifold outlet. The close-coupled catalyst can be connected directly to the gasoline engine outlet or exhaust manifold outlet. Alternatively, it can be connected by a short exhaust pipe, typically up to about one foot long to the exhaust outlet or exhaust manifold outlet of the gasoline engine. The close-coupled catalyst has an outlet which is connected in communication with the inlet of the downstream preferably underfloor catalytic converter. Exhaust pipes can be connected from the outlet of the close-coupled catalyst outlet and the inlet of the underfloor catalytic converter inlet. The underfloor catalytic converter has an outlet which can be connected to outlet exhaust pipes through which the exhaust gas passes from the vehicle into the atmosphere. The close-coupled catalyst comprises a close-coupled catalyst composition. The underfloor catalyst preferably comprises a NOx trap containing ceria.

As used herein, the following terms, whether used in singular or plural form, have the meaning defined below.

The term “catalytic metal component”, or “platinum metal component”, or reference to a metal or metals comprising the same, means a catalytically effective form of the metal or metals, whether the metal or metals are present in elemental form, or as an alloy or a compound, e.g., an oxide.

The term “component” or “components” as applied to NOₓ sorbents means any effective NOₓ-trapping forms of the metals, e.g., oxygenated metal compounds such as metal hydroxides, mixed metal oxides, metal oxides or metal carbonates.

The term “dispersed”, when applied to a component dispersed onto a bulk support material, means immersing the bulk support material into a solution or other liquid suspension of the component or a precursor thereof. For example, the sorbent strontium oxide may be dispersed onto an alumina support material by soaking bulk alumina in a solution of strontium nitrate (a precursor of strontia), drying the soaked alumina particles, and heating the particles, e.g., in air at a temperature from about 450° C. to about 750° C. (calcining) to convert the strontium nitrate to strontium oxide dispersed on the alumina support materials.

The term “gaseous stream” or “exhaust gas stream” means a stream of gaseous constituents, such as the exhaust of an internal combustion engine, which may contain entrained non-gaseous components such as liquid droplets, solid particulates, and the like.

The terms “g/in³” or “g/ft³” or “g/ft³” used to describe weight per volume units describe the weight of a component per volume of catalyst or trap member including the volume attributed to void spaces such as gas-flow passages.

The term “lean” mode or operation of treatment means that the gaseous stream being treated contains more oxygen that the stoichiometric amount of oxygen needed to oxidize the entire reductants content, e.g., HC, CO and H₂, of the gaseous stream.

The term “mixed metal oxide” means bi-metallic or multi-metallic oxygen compounds, such as Ba₂SrWO₆, which are true compounds and is not intended to embrace mere mixtures of two or more individual metal oxides such as a mixture of SrO and BaO.

The term “platinum group metals” means platinum, palladium, rhodium in combination with platinum or palladium, and mixtures thereof, including Pt/Pd, Pt/Rh, and Pd/Rh, as well as trimetallic platinum group metal components.

The term “sorb” means to effect sorption.

The term “stoichiometric/rich” mode or operation of treatment means that the gaseous stream being treated refers collectively to the stoichiometric and rich operating conditions of the gas stream.

The abbreviation “TOS” means time on stream.

The term “washcoat” has its usual meaning in the art of a thin, adherent coating of a catalytic or other material applied to a refractory carrier material, such as a honeycomb-type carrier member, which is sufficiently porous to permit the passage therethrough of the gas stream being treated.

In a specific embodiment, the present invention is directed to an article comprising:

(A) a lean burn gasoline engine having an exhaust outlet;

(B) an upstream section having a close coupled catalyst composite in communication with the exhaust outlet, the upstream close coupled catalyst composite comprising:

(i) a first support;

(ii) a first platinum group component; and

(iii) a SOₓ sorbent component selected from the group consisting of oxides and mixed oxides of barium, lanthanum, magnesium, manganese, neodymium, praseodymium, and strontium; and

(C) a downstream section comprising:

(i) a second support;

(ii) a second platinum group component; and

(iii) a NOₓ sorbent component;

wherein the upstream section has substantially no components adversely affecting three-way conversion under operating conditions.

As set out above, the present invention includes an upstream close coupled catalyst composite section and a downstream section. The upstream section includes a first support and the downstream section includes a second support, made of a high surface area refractory oxide support. The support may be selected from the group consisting of alumina, titania, and zirconia compounds, and mixtures thereof. Useful high surface area supports include one or more refractory oxides. These oxides include, for example, metal oxides such as alumina, including mixed oxide forms which may be amorphous or crystalline, alumina-zirconia, alumina-ceria and the like. Preferably the support is an activated compound selected from the group consisting of alumina, alumina-zirconia, and alumina-ceria. More preferably, the support is activated alumina. Desirably, the active alumina has a specific surface area of 60 to 300 m²/g. Preferably, the first and second supports are independently selected from the group consisting of alumina, titania, and zirconia compounds. More preferably, the first and second supports are selected from the group consisting of activated alumina, alumina-zirconia, and alumina-ceria.

The upstream section also includes a first platinum group component and the downstream section includes a second group platinum component. The first and second platinum group metal components may be selected from the group consisting of platinum, palladium, rhodium in combination with platinum or palladium, and mixtures thereof, including Pt/Pd, Pt/Rh, and Pd/Rh, as well as trimetallic platinum group metal components. The upstream section may further comprise a third platinum group metal component different from the first platinum group metal component. The downstream section may further comprise a fourth platinum group metal component different from the second platinum group metal component.

In accord with the present invention, the upstream close coupled catalyst composite includes a SOₓ sorbent component which adsorbs SOx under all temperature conditions under lean conditions (both ambient and operating conditions). As set out above, during steady state operation of the engine, the proximity of the close-coupled catalyst to the engine, typically less than one foot, more typically less than six inches and commonly attached directly to the outlet of the exhaust manifold exposes the close-coupled catalyst composition to exhaust gases at very high temperatures of up to 1100° C. The SOₓ sorbent component in the close-coupled catalyst in the catalyst bed is heated to high temperature by heat from both the hot exhaust gas and by heat generated by the combustion of hydrocarbons and carbon monoxide present in the exhaust gas. In addition to being very reactive at low temperatures, the SOₓ sorbent component in the close-coupled catalyst composition must be stable at high temperatures during the operating life of the engine. The SOₓ sorbent component must also have the ability to sorb and desorb SOₓ at high temperatures without adversely affecting three-way conversion under operating conditions. Suitable SOₓ sorbent components may be selected from the group consisting of oxides and mixed oxides of barium, lanthanum, magnesium, manganese, neodymium, praseodymium, and strontium. In one embodiment, the SOₓ sorbent component is selected from the group consisting of oxides and mixed oxides of barium, lanthanum, magnesium, neodymium, praseodymium, and strontium. In another embodiment, the SOₓ sorbent component is selected from the group consisting of oxides and mixed oxides of barium, lanthanum, and magnesium. In yet another embodiment, the SOₓ sorbent component is selected from the group consisting of oxides and mixed oxides of neodymium, praseodymium, and strontium. In a preferred another embodiment, the SOₓ sorbent component is La₂O₃. In general, alkali metals are not suitable SOₓ sorbent components because alkali metals adversely affect three-way conversion under operating conditions. The amount of SOx trap present will in general be in the range from about 0.1 g/in³ to about 2 g/in³, preferably from about 0.5 g/in³ to about 1.0 g/in³. The SOx trap is in general prepared as a dispersion and post impregnated on the wash coat. The SOx trap may also be added as a soluble salt to the slurry or impregnated on the support.

The close coupled catalyst composite of the present invention protects the lean NOx trap (in under floor position) from sulfur poisoning by using sulfur trap in a close couple position. The close couple sulfur trap is also used for three-way catalyst application to reduce NOx, hydrocarbons, and carbon monoxide at stoichiometric or rich conditions as three-way catalyst as well as a sulfur trap. The use of a sulfur trap in close couple position will allow for trapping the sulfur (as SO₂ or SO₃) by the close couple (also sulfur trap) and prevent it from adsorbing on the lean NOx trap. Sulfur adsorbed on the lean NOx trap in under floor position results in decreasing the NOx efficiency. Combining the sulfur trap with the close couple catalyst will eliminate the use a separate substrate for sulfur trapping. Moreover, locating the sulfur trap in close couple position will enhance its desulfation due to the higher temperature at the close couple position compared to under floor position. The use of a three-way catalyst made of Pt/Rh/Pd supported on alumina or other metal oxides to trap sulfur is provided by adding a SOₓ sorbent component selected from the group consisting of oxides and mixed oxides of barium, lanthanum, magnesium, manganese, neodymium, praseodymium, and strontium.

The close-coupled catalyst composition of the present invention preferably contains oxygen storage components such as ceria. When present, the maximum concentration of oxygen storage components will be 0.75 g/in³, preferably 0.5 g/in³. The catalyst composition comprises a support which preferably comprises at least one compound selected from the group consisting of silica, alumina, titania and a first zirconia compound hereinafter referred to as a first zirconia compound. The composition further comprises a palladium component, preferably in an amount sufficient to oxidize carbon monoxide and hydrocarbons and reduce nitric oxides to have respective light-off temperatures at 50% conversion which are relatively low and preferably in the range of from 200° C. to 350° C. for the oxidation of hydrocarbons. The composition optionally comprises at least one alkaline earth etal oxide selected from the group consisting of strontium oxide, calcium oxide, and barium oxide. The composition can optionally also comprise other precious metal or platinum group metal components, preferably including at least one metal selected from the group consisting of platinum, rhodium in combination with platinum or palladium. Where additional platinum group metals are included, if platinum is used, it is used in an amount of less than 60 grams per cubic foot. Other platinum group metals are used in amounts of up to about 20 grams per cubic foot. The composition optionally also can include a second zirconium oxide compound as a stabilizer and optionally at lease one rare earth oxide selected from the group consisting of neodymium oxide, praseodymium oxide, and lanthanum oxide.

The close-coupled catalyst preferably is in the form of a carrier supported catalyst where the carrier comprises a honeycomb type carrier. A preferred honeycomb type carrier comprises a composition having at least about 50 to about 200 grams per cubic foot of a platinum group component, from about 0.5 to about 3.0 g/in³ of a support, and from about 0.05 to about 1.0 g/in³ of a SOₓ sorbent component.

The present invention comprises a method of operating a gasoline engine having an exhaust which comprises pollutants including carbon monoxide, hydrocarbons, nitrogen oxides, and sulfur oxides. The exhaust gas stream is passed from the engine outlet to the inlet of a close-coupled catalyst of the type described above. The gases contact with the close-coupled catalyst and reacts.

The downstream section includes a NOₓ sorbent component. Preferably, the NOₓ sorbent component is selected from the group consisting of alkaline earth metal components, alkali metal components, and rare earth metal components. More preferably, the NOₓ sorbent component is selected from the group consisting of oxides of calcium, strontium, and barium, oxides of potassium, sodium, lithium, and cesium, and oxides of cerium, lanthanum, praseodymium, and neodymium. In one embodiment, the NOₓ sorbent component is selected from the group consisting of oxides of calcium, strontium, and barium. In another embodiment, the NOₓ sorbent component is selected from the group consisting of oxides of potassium, sodium, lithium, and cesium. In another embodiment, the NOₓ sorbent component is selected from the group consisting of oxides of cerium, lanthanum, praseodymium, and neodymium. In another embodiment, the NOₓ sorbent component is at least one alkaline earth metal component and at least one rare earth metal component such as lanthanum or neodymium.

In a specific embodiment, the present invention relates to a method for removing NOₓ and SOₓ contaminants from a gaseous stream comprising the steps of:

(A) operating a lean burn gasoline engine having an exhaust outlet;

(B) providing an upstream section comprising a close coupled catalyst composite in communication with the exhaust outlet and a downstream section:

(1) the upstream section having a close coupled catalyst composite comprising:

(i) a first support;

(ii) a first platinum group component; and

(iii) a SOₓ sorbent component selected from the group consisting of oxides and mixed oxides of barium, lanthanum, magnesium, manganese, neodymium, praseodymium, and strontium; and

(2) the downstream section comprising:

(i) a second support;

(ii) a second platinum group component; and

(iii) a NOₓ sorbent component;

wherein the upstream section has substantially no components adversely affecting three-way conversion under operating conditions;

(C) in a sorbing period, passing a lean gaseous stream comprising NOₓ and SOₓ within a sorbing temperature range through the upstream section to sorb at least some of the SOₓ contaminants and thereby provide a SOₓ depleted gaseous stream exiting the upstream section and entering the downstream section to sorb and abate at least some of the NOₓ contaminants in the gaseous stream and thereby provide a NOₓ depleted gaseous stream exiting the downstream section;

(D) in a SOₓ desorbing period, converting the lean gaseous stream to a rich gaseous stream and raising the temperature of the gaseous stream to within a desorbing temperature range to thereby reduce and desorb at least some of the SOₓ contaminants from the upstream section and thereby provide a SOₓ enriched gaseous stream exiting the upstream section; and

(E) in a NOₓ desorbing period, converting the lean gaseous stream to a rich gaseous stream to thereby desorb and reduce at least some of the NOₓ contaminants from the downstream section and thereby provide a NOₓ enriched gaseous stream exiting the downstream section.

In use, the exhaust gas stream, comprising hydrocarbons, carbon monoxide, nitrogen oxides, and sulfur oxides and which is contacted with the close coupled catalyst composite of the present invention, is alternately adjusted between lean and stoichiometric/rich operating conditions so as to provide alternating lean operating periods and stoichiometric/rich operating periods. The exhaust gas stream being treated may be selectively rendered lean or stoichiometric/rich either by adjusting the air-to-fuel ratio fed to the engine generating the exhaust or by periodically injecting a reductant into the gas stream upstream of the catalyst. A suitable reductant, such as fuel, may be periodically sprayed into the exhaust immediately upstream of the catalytic trap of the present invention to provide at least local (at the catalytic trap) stoichiometric/rich conditions at selected intervals. Partial lean-burn engines, such as partial lean-burn gasoline engines, are designed with controls which cause them to operate lean with brief, intermittent rich or stoichiometric conditions. In practice, the close coupled catalyst composite absorbs in-coming SOₓ during a lean mode operation (up to 600° C.) and desorbs SOₓ during a rich mode operation (greater than about 550° C., preferably greater than about 600° C., more preferably greater than about 650° C., and most preferably greater than about 700° C.). When the exhaust gas temperature returns to a lean mode operation (for example, 300° C.), the regenerated close coupled catalyst composite can again selectively absorb in-coming SOₓ. The duration of the lean mode may be controlled so that the close coupled catalyst composite will not be saturated with SOₓ.

The invention will be better understood from the following detailed description of the preferred embodiments taken in conjunction with the FIGS., in which like elements are represented by like referenced numerals.

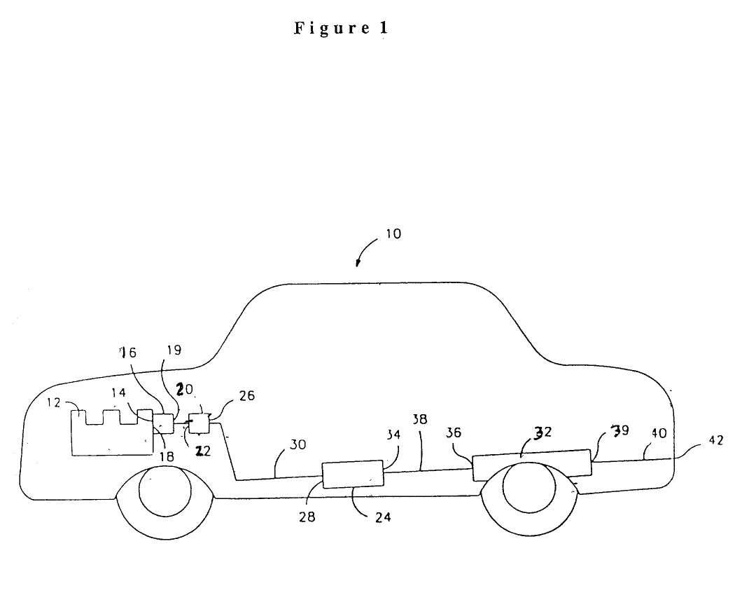

FIG. 1 illustrates a particular and preferred embodiment of the present invention. FIG. 1 shows a motor vehicle 10 having a gasoline engine 12 and an engine exhaust outlet 14. The engine exhaust outlet 14 communicates to an engine exhaust manifold 16 through a manifold inlet 18. The engine exhaust manifold 16 also has an engine exhaust manifold outlet 19. A close-coupled catalyst 20 is in close proximity to the engine exhaust manifold outlet 19. The engine exhaust manifold outlet 19 is connected to and communicates with close-coupled catalyst 20 through close-coupled catalyst inlet 22. Close-coupled catalyst 20 has a first support, a first platinum group component and a SOₓ sorbent component. The close-coupled catalyst 20 is connected to and communicates with a downstream catalyst, such as underfloor catalytic converter 24. Downstream catalyst 24 has a second support, a second platinum group component, and a NOₓ sorbent component. The close-coupled catalyst 20 has a close-coupled catalyst outlet 26 which is connected to the underfloor catalyst 24 through the close-coupled catalyst exhaust pipe 30 to under floor catalyst inlet 28. The underfloor catalyst 24 is typically and preferably connected to muffler 32. In particular, the underfloor catalyst outlet 34 is connected to the muffler inlet 36 through underfloor exhaust pipe 38. The muffler has a muffler outlet 39 which is connected to tail pipe 40 having a tail pipe outlet 42 which opens to the environment.

The article of the present invention preferably includes a close-coupled catalyst composition comprising a support; a palladium, platinum, or rhodium in combination with platinum or palladium. The composition provides three way catalyst activity and consists essentially no ceria, no oxygen storage components and in particular, substantially no ceria or praseodymia. The close-coupled catalyst composition can optionally comprise, in addition to palladium, at least one platinum group metal component selected from the group consisting of platinum, rhodium, in minor amounts relative to the palladium. Optionally and preferably, the composition further comprises at least one alkaline earth metal oxide and at least one rare earth oxide selected from the group consisting of neodymium oxide and lanthanum oxide. The composition further can optionally comprise a second zirconium oxide compound. The close-coupled catalyst composition is preferably coated on to a carrier such as a honeycomb substrate carrier.

When coated on to such a carrier, the amounts of the various components are presented based on grams per volume. When the compositions are applied as a thin coating to a monolithic carrier substrate, the amounts of ingredients are conventionally expressed as grams per cubic foot for platinum group metal components and grams of material per cubic inch of catalyst as this measure accommodates different gas flow passage cell sizes in different monolithic carrier substrates. For typical automotive exhaust gas catalytic converters, the catalyst composite which includes a monolithic substrate generally may comprise from about 0.50 to about 6.0, preferably about 1.5 to about 4.0 g/in³ of catalytic composition coating. Preferably, the catalyst composite comprises from about 50 to about 200 g/ft³ of a platinum group component. In order to attain the desired oxidation of hydrocarbon and controlled oxidation of carbon monoxide, the amount of palladium is preferably greater than the sum of all of the other platinum group metal components.

The close-coupled catalyst composition, but more preferably the downstream composition of the present invention can contain other conventional additives such as sulfide suppressants, e.g., nickel, manganese, or iron components. If nickel oxide is used, an amount from about 1 to 25% by weight of the first coat can be effective.

The close-coupled catalyst composition of the present invention and the downstream catalyst composition of the present invention can be prepared and formed into pellets by known means or applied to a suitable substrate, preferably a metal or ceramic honeycomb carrier.

Any suitable carrier may be employed, such as a monolithic carrier of the type having a plurality of fine, parallel gas flow passages extending therethrough from an inlet or an outlet face of the carrier, so that the passages are open to fluid flow therethrough. The passages, which are essentially straight from their fluid inlet to their fluid outlet, are defined by walls on which the catalytic material is coated as a “washcoat” so that the gases flowing through the passages contact the catalytic material. The flow passages of the monolithic carrier are thin-walled channels which can be of any suitable cross-sectional shape and size such as trapezoidal, rectangular, square, sinusoidal, hexagonal, oval, circular. Such structures may contain from about 60 to about 600 or more gas inlet openings (“cells”) per square inch of cross section. The ceramic carrier may be made of any suitable refractory material, for example, cordierite, cordierite-alpha alumina, silicon nitride, zircon mullite, spodumene, alumina-silica magnesia, zircon silicate, sillimanite, magnesium silicates, zircon, petalite, alpha alumina and aluminosilicates. The metallic honeycomb may be made of a refractory metal such as a stainless steel or other suitable iron based corrosion resistant alloys.

Such monolithic carriers may contain up to about 900 or more flow channels (“cells”) per square inch of cross section, although far fewer may be used. For example, the carrier may have from about 400 to 900 cells per square inch (“cpsi”).

The present invention is illustrated further by the following examples which are not intended to limit the scope of this invention.

### EXAMPLES

The following examples are presented to provide more complete understanding of the invention. The specific techniques, conditions, materials, proportions and reported data set forth to illustrate the principles and practice of the invention are exemplary and should not be construed as limiting the scope of the invention.

Example 1

The effectiveness of the close couple sulfur trap to minimize the poisoning of the NOx trap by fuel sulfur was evaluated in a lab reactor using the following procedure. The system (close couple S trap+NOx trap aged 800° C. for 12 hours) was evaluated after several sulfation and desulfation cycles. The sulfation cycle was carried out for 20 minutes using 50 PPM sulfur at a space velocity of 40,000/h. The catalyst and the S trap sizes were 1.5″ diameter by 3.0″ length & 1.5″ diameter by 1.5″ length respectively. The sulfation procedure was carried out at 400° C. using lean/rich cycles: 60 s lean @ lambda=1.5 & 6 s rich @ lambda 0.86. The space velocity was 40,000/h and gas composition at lean conditions was: 500 PPM NO, 7.5% oxygen, 10% steam, 10% CO₂, 50 PPM SO₂, 50 PPM C₃H₆. The rich condition was obtained by replacing the oxygen by CO. After sulfation, the trap was desulfated at 650-660° C. using rich conditions using excess CO. The use of rich conditions is necessary to release the SO₂ and recover the NOx trapping efficiency. After desulfation for 15 minutes, the temperature was dropped to 400° C. and the NOx capacity was measured. The NOx trap capacity was used as a measure of recovery of the system from the S poisoning. It was measured by applying rich conditions at 400° C. @ lambda 0.86 for 1 minute followed by lean conditions @ lambda=1.5 for 5 minutes. The cumulative NOx was measured as a function of NOx trap conversion. The NOx capacity at 80% NOx conversion was used to determine the NOx trapping performance. After over 6 cycles of sulfation and desulfation, the NOx capacity was 0.6-0.8 g of NO₂/liter of catalyst. This is similar to fresh activity before the sulfation. This is a clear indication that the close couple S trap protected the NOx trap from S poisoning which is a major reason for NOx trap deactivation.

Example 2

S-Trap-NOx trap system:

A SOx trap material, lanthanum nitrate was impregnated on a fully formulated close coupled type catalyst (see Example 1). The size substrate was 4.0″×6.0″ and contains 150 g/ft³ of PM with a ratio of 1:13:1. The intention of this close couple catalyst was to remove hydrocarbon and NOx from the exhaust at stoichiometric (Lambda=1.0 conditions) . The close couple catalyst was then impregnated with lanthanum nitrate solution to a level of La₂O₃ after calcination of 0.4 g/in³. The La₂O₃ modification was intended to remove the S from the exhaust during the lean portion of the operation without penalizing the catalyst good performance for removing the NOx, hydrocarbons, and CO from the exhaust during the stoichiometric operation (i.e., lambda 1.0). The catalyst was evaluated in a system with the close couple in front of a lean NOx trap/catalyst. Two systems were evaluated after 10 h aging at 700° C. One system, reference, is made of close couple and under floor lean NOx trap. This is the reference TWC catalyst/NOx trap system. The reference TWC catalyst/NOx trap system is compared with a modified system. The only difference between the two systems is the additional lanthanum oxide component in the front (close couple position) which is used to trap the S emitted from the exhaust during the lean portion of the driving cycle.

Reference system: Front close couple TWC catalyst and Lean NOx trap in under floor position.

Invention System: Same close couple catalyst impregnated with La₂O₃ and same under floor as reference system.

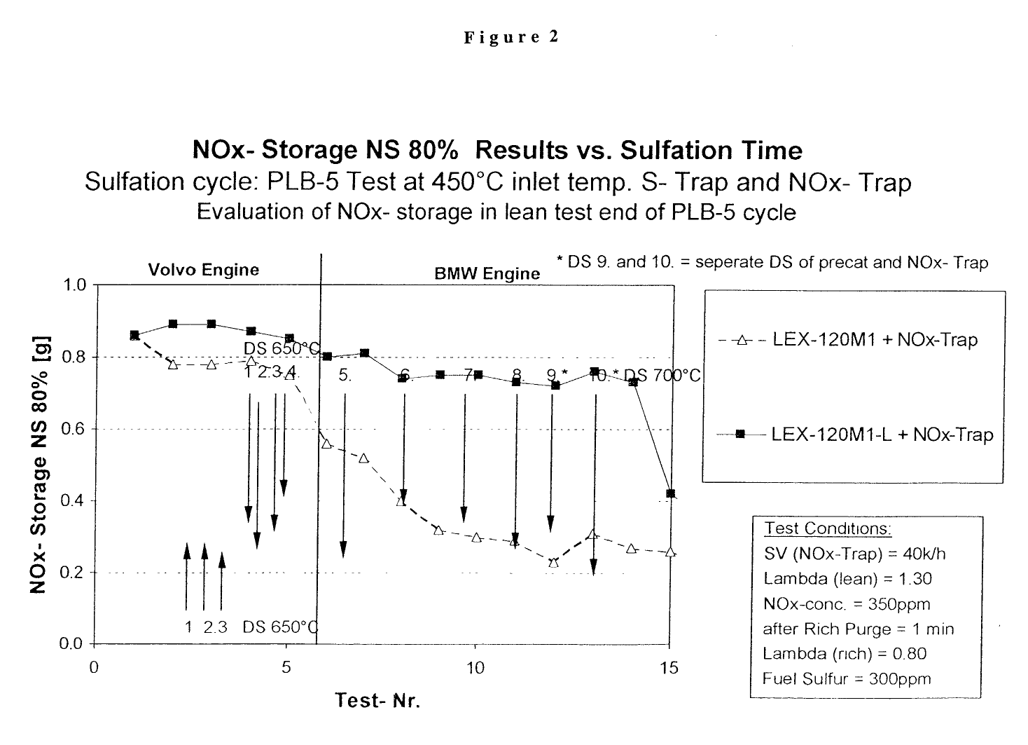

The two systems were engine aged at 700° C. for 10 hours. The systems were then subjected at 450° C. for fuel containing 300 PPM S (20 PPM as SOx in the exhaust) for extended period of time (total 15 hours). After each hour the system was desulfated and evaluated on the engine using a lean/rich cycle (lean 1 minute and rich 2 seconds). The NOx trapping capacity was then measured at 80% NOx trapping efficiency. The trapping efficiency at lean conditions is a function only of the NOx trap located in the under floor position. The results of the test are given in FIG. 2.

FIG. 2 shows that reference system was poisoned severely after 5 hours in the exhaust. SO₂ is a very well known poison for these NOx trap catalysts. The NOx trap capacity went down from over 0.8 g of NOx to about 0.2 g of NOx after about 12 hours. On the other the system per this invention showed good resiliency for sulfur poisoning and the sulfur in the exhaust was completely removed by the designed sulfur trap in the front catalyst brick (close couple catalyst). After about 14 hours on stream in the engine exhaust, the NOx trap capacity (measured on the under floor brick) dropped only from about 0.85 to about 0.75 g of NOx. Moreover, no sulfur was detected in between the front and under floor brick during the lean operation.

It is clear that using a S trap component such as La₂O₃ in the close couple position would minimize the sulfur poisoning of the under floor NOx trap without penalizing the performance of the front (CC) brick during the stoichiometric operation.

The are many advantages of this system. The choice of La₂O₃ is an excellent sulfur trap. There is no need for an extra brick for removing S. A separate brick would require additional precious metal and canning. The presence of a S trap in the close couple position is more convenient and practical to desulfate than a sulfur trap in the under floor position. This is due to the sulfur trap proximity to the manifold (trap will see higher temperatures) and the combustion of HC on the front catalyst which raises automatically the trap temperature and allow for more practical desulfation conditions. The use of lanthanum minimizes loss of S at low temperature, lanthanum sulfate is very stable and requires high temperatures (>650° C.) to desulfate. This prevents the non-intended desulfation at low temperatures. The use of La in the front catalyst has no negative impact on emission during stoichiometric operation. The use of alkali metals that are known as good sulfur trap, for example, will result in significantly poisoning the NOx, hydrocarbon, and CO at stoichiometric conditions.

Modifications, changes, and improvements to the preferred forms of the invention herein disclosed, described and illustrated may occur to those skilled in the art who come to understand the principles and precepts thereof. Accordingly, the scope of the patent to be issued hereon should not be limited to the particular embodiments of the invention set forth herein, but rather should be limited by the advance of which the invention has promoted the art.

We claim:

1. An article comprising:
(A) a lean burn gasoline engine having an exhaust outlet;
(B) an upstream section having a close coupled catalyst composite in communication with the exhaust outlet, the upstream close coupled catalyst composite comprising:
(i) a first support;
(ii) a first platinum group component; and
(iii) a SOₓ sorbent component selected from the group consisting of oxides and mixed oxides of barium, lanthanum, magnesium, manganese, neodymium, praseodymium, and strontium; and
(C) a downstream section comprising:
(i) a second support;
(ii) a second platinum group component; and
(iii) a NOₓ sorbent component;
wherein the upstream section has substantially no components adversely affecting three-way conversion under operating conditions.

2. The article according to claim 1, wherein the first and second supports are independently selected from the group consisting of alumina, titania, and zirconia compounds.

3. The article according to claim 2, wherein the first and second supports are independently selected from the group consisting of alumina, alumina-zirconia, and alumina-ceria.

4. The article according to claim 1, wherein the first platinum group metal component is selected from the group consisting of platinum, palladium, rhodium in combination with platinum or palladium, and mixtures thereof.

5. The article according to claim 1, wherein the upstream section further comprises a third platinum group metal component different from the first platinum group metal component.

6. The article according to claim 1, wherein the second platinum group metal component is selected from the group consisting of platinum, palladium, rhodium in combination with platinum or palladium, and mixtures thereof.

7. The article according to claim 1, wherein the downstream section further comprises a fourth platinum group metal component different from the second platinum group metal component.

8. The article according to claim 1, wherein the SOₓ sorbent component is selected from the group consisting of oxides and mixed oxides of barium, lanthanum, magnesium, neodymium, praseodymium, and strontium.

9. The article according to claim 8, wherein the SOₓ sorbent component is selected from the group consisting of oxides and mixed oxides of barium, lanthanum, and magnesium.

10. The article according to claim 8, wherein the SOₓ sorbent component is selected from the group consisting of oxides and mixed oxides of neodymium, praseodymium, and strontium.

11. The article according to claim 8, wherein the SOₓ sorbent component is La₂O₃.

12. The article according to claim 1, wherein the NOₓ sorbent component is selected from the group consisting of alkaline earth metal components, alkali metal components, and rare earth metal components.

13. The article according to claim 12, wherein the NOₓ sorbent component is selected from the group consisting of oxides of calcium, strontium, and barium, oxides of potassium, sodium, lithium, and cesium, and oxides of cerium, lanthanum, praseodymium, and neodymium.

14. The article according to claim 13, wherein the NOₓ sorbent component is selected from the group consisting of oxides of calcium, strontium, and barium.

15. The article according to claim 13, wherein the NOₓ sorbent component is selected from the group consisting of oxides of potassium, sodium, lithium, and cesium.

16. The article according to claim 12, wherein the NOₓ sorbent component is at least one alkaline earth metal component and at least one rare earth metal component selected from the group consisting of lanthanum and neodymium.

17. The article according to claim 1, wherein the upstream section or the downstream section, or both, further comprises a zirconium component.

18. The article according to claim 1, wherein the upstream substrate or the downstream substrate, or both, is supported on a metal or ceramic honeycomb carrier or is self-compressed.

19. A method for removing NOₓ and SOₓ contaminants from a gaseous stream comprising the steps of:
(A) operating a lean burn gasoline engine having an exhaust outlet;
(B) providing an upstream section comprising a close coupled catalyst composite in communication with the exhaust outlet and a downstream section:
(1) the upstream section having a close coupled catalyst composite comprising:
(i) a first support;
(ii) a first platinum group component; and
(iii) a SOₓ sorbent component selected from the group consisting of oxides and mixed oxides of barium, lanthanum, magnesium, manganese, neodymium, praseodymium, and strontium; and
(2) the downstream section comprising:
(i) a second support;
(ii) a second platinum group component; and
(iii) a NOₓ sorbent component;
wherein the upstream section has substantially no components adversely affecting three-way conversion under operating conditions;
(C) in a sorbing period, passing a lean gaseous stream comprising NOₓ and SOₓ within a sorbing temperature range through the upstream section to sorb at least some of the SOₓ contaminants and thereby provide a SOₓ depleted gaseous stream exiting the upstream section and entering the downstream section to sorb and abate at least some of the NOₓ contaminants in the gaseous stream and thereby provide a NOₓ depleted gaseous stream exiting the downstream section;
(D) in a SOₓ desorbing period, converting the lean gaseous stream to a rich gaseous stream and raising the temperature of the gaseous stream to within a desorbing temperature range to thereby reduce and desorb at least some of the SOₓ contaminants from the upstream section and thereby provide a SOₓ enriched gaseous stream exiting the upstream section; and
(E) in a NOₓ desorbing period, converting the lean gaseous stream to a rich gaseous stream to thereby desorb and reduce at least some of the NOₓ contaminants from the downstream section and thereby provide a NOₓ enriched gaseous stream exiting the downstream section.

20. The method according to claim 19, wherein the first and second supports are independently selected from the group consisting of alumina, titania, and zirconia compounds.

21. The method according to claim 20, wherein the first and second supports are independently selected from the group consisting of alumina, alumina-zirconia, and alumina-ceria.

22. The method according to claim 19, wherein the first platinum group metal component is selected from the group consisting of platinum, palladium, rhodium in combination with platinum or palladium, and mixtures thereof.

23. The method according to claim 19, wherein the upstream section further comprises a third platinum group metal component different from the first platinum group metal component.

24. The method according to claim 19, wherein the second platinum group metal component is selected from the group consisting of platinum, palladium, rhodium in combination with platinum or palladium, and mixtures thereof.

25. The method according to claim 19, wherein the downstream section further comprises a fourth platinum group metal component different from the second platinum group metal component.

26. The method according to claim 19, wherein the SOₓ sorbent component is selected from the group consisting of oxides and mixed oxides of barium, lanthanum, magnesium, neodymium, praseodymium, and strontium.

27. The method according to claim 26, wherein the SOₓ sorbent component is selected from the group consisting of oxides and mixed oxides of barium, lanthanum, and magnesium.

28. The method according to claim 26, wherein the SOₓ sorbent component is selected from the group consisting of oxides and mixed oxides of neodymium, praseodymium, and strontium.

29. The method according to claim 26, wherein the SOₓ sorbent component is La₂O₃.

30. The method according to claim 29, wherein the NOₓ sorbent component is selected from the group consisting of oxides of calcium, strontium, and barium, oxides of potassium, sodium, lithium, and cesium, and oxides of cerium, lanthanum, praseodymium, and neodymium.

31. The method according to claim 29, wherein the NOₓ sorbent component is selected from the group consisting of oxides of calcium, strontium, and barium.

32. The method according to claim 29, wherein the NOₓ sorbent component is selected from the group consisting of oxides of potassium, sodium, lithium, and cesium.

33. The method according to claim 19, wherein the NOₓ sorbent component is at least one alkaline earth metal component and at least one rare earth metal component selected from the group consisting of lanthanum and neodymium.

34. The method according to claim 19, wherein the upstream section or the downstream section, or both, further comprises a zirconium component.

35. The method according to claim 19, wherein the upstream substrate or the downstream substrate, or both, is supported on a metal or ceramic honeycomb carrier or is self-compressed.

36. The method according to claim 19, wherein the SOₓ desorbing temperature range in (D) is greater than about 550° C.

37. The method according to claim 19, wherein the SOₓ desorbing temperature range in (D) is greater than about 600° C.

38. The method according to claim 19, wherein the SOₓ desorbing temperature range in (D) is greater than about 650° C.

39. The method according to claim 19, wherein the SOₓ desorbing temperature range in (D) is greater than about 700° C.

40. A method of forming a catalyst composite having a close coupled upstream section and a downstream section which comprises the steps of:
(A) forming a close coupled upstream section comprising:
(i) a first support;
(ii) a first platinum group component; and
(iii) a SOₓ sorbent component selected from the group consisting of oxides and mixed oxides of barium, lanthanum, magnesium, manganese, neodymium, praseodymium, and strontium; and
(B) forming a downstream section comprising:
(i) a second support;
(ii) a second platinum group component; and
(iii) a NOₓ sorbent component;
wherein the upstream section has substantially no components adversely affecting three-way conversion under operating conditions.
